(19) United States
(12) Patent Application Publication
(10) Pub. No.: US 2002/0171976 A1
(43) Pub. Date: Nov. 21, 2002

(54) Cost effective head cleaning disk

(76) Inventors: Yiping Ma, Layton, UT (US); James M. Bero, Ogden, UT (US)

Correspondence Address: Richard E. Kutz, WOODCOCK WASHBURN KURTZ, MACKIEWICZ & NORRIS LLP, One Liberty Place - 46th Floor, Philadelphia, PA, 19103, US

(21) Appl. No.: 09/858,849

(22) Filed: May 16, 2001

(51) Int. Cl. G11B 5/127

(52) U.S. Cl. 360/128

(57) ABSTRACT

A cleaning cartridge for a removable cartridge data storage drive includes a textured substrate and a diamond-like coating directly on the substrate. The textured substrate is mounted on a hub which is rotated on a hub which is rotated by a spindle motor in the drive. The cleaning disk has the same thickness as a normal magnetic disk but does not have magnetic film or under layers.

### BACKGROUND

1. Field of the Invention

This invention relates to cleaning the magnetic heads of a data storage device and more particularly to a head cleaning cartridge which is cost effective.

2. Description of the Prior Art

Periodically, magnetic heads must be cleaned to prevent head degradation due to contamination build-up on the surfaces of the heads.

Recently disk drives have been developed using hard disk technology. U.S. Pat. No. 5,666,236, Bracken et al. and U.S. Pat. No. 5,570,252, Bracken et al. show a disk drive and a removable cartridge having a hard disk and a type of head suspension referred to as “Winchester.” Such drives are available from Iomega Corporation as JAZ® drives and cartridges. The high performance of the hard disk technology depends on a very clean interface between the head and the disk. Debris may build up at the leading edge of the slider and may even cover up the gap. There is intimate contact between the head and disk, sometimes referred to as pseudo-contact. In order to maintain this critical pseudo-contact between head and disk, it is important that the head be clean.

It has been observed that debris buildup can be removed to a certain degree when the slider is brought into intimate contact with the recording media during contact-start-stop or flying at a rotational speed that is below the take-off speed of the slider. Therefore the recording media can be an ideal candidate for a cleaning cartridge.

However, when the recording media is used as the cleaning cartridge, substantial material and process waste occur. The magnetic coating on the recording media is not needed as a cleaning media. Consequently the associated steps of applying the coating and undercoating are wasted as well.

It is an object of the present invention to provide a cost effective cleaning cartridge.

### SUMMARY OF THE INVENTION

In accordance with the present invention, a cleaning cartridge has a textured substrate on which a diamond-like coating is directly deposited. The substrate is mounted on a hub in the shell of the cartridge. When the cleaning cartridge is inserted into the drive the hub is rotated so that the textured surface cleans the heads of the disk drive through light abrasion between the slider and disk surfaces.

The foregoing and other objects, features and advantages of the invention will be better understood from the following more detailed description and appended claims.

### SHORT DESCRIPTION OF THE INVENTION

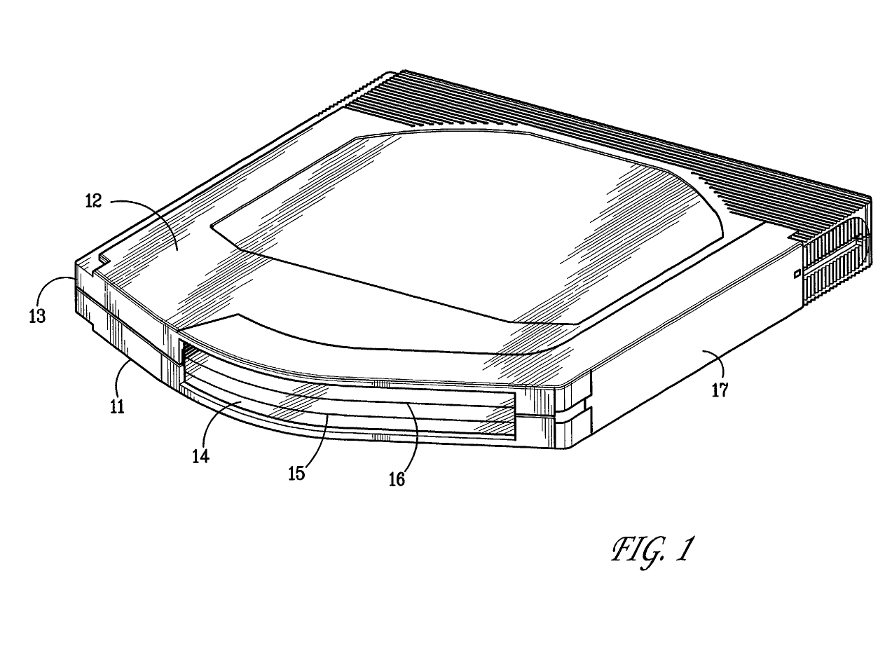

FIG. 1 shows an isometric view of a data storage cartridge;

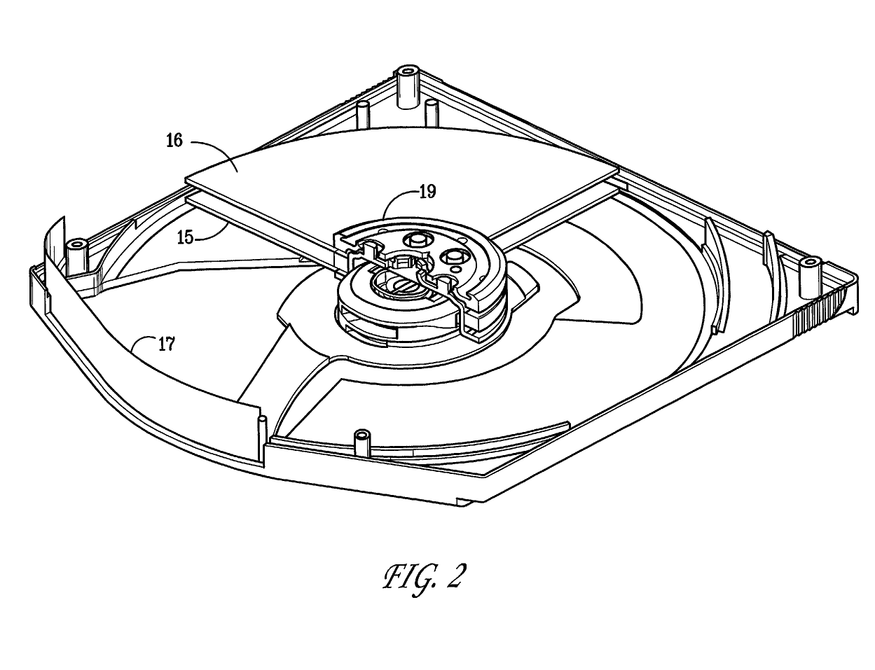

FIG. 2 show a data storage cartridge of FIG. 1 with the top half shelf removed;

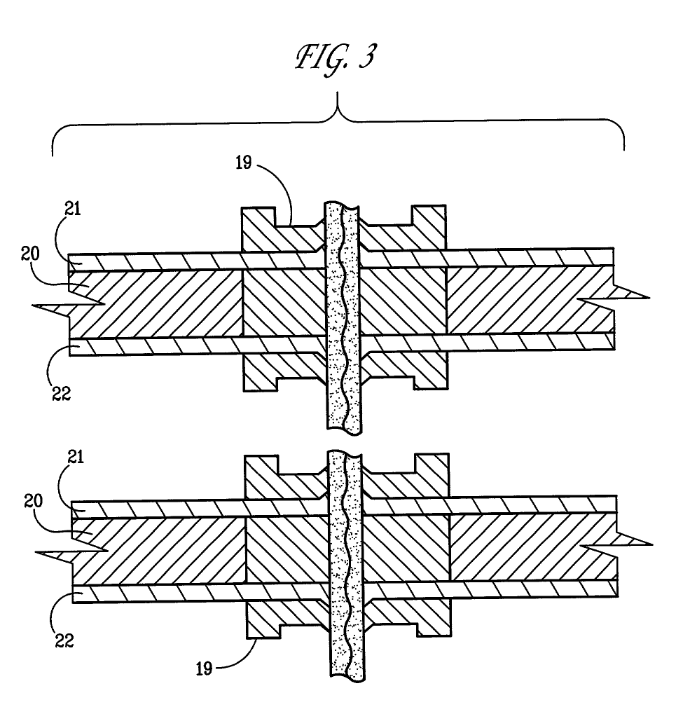

FIG. 3 shows the cleaning disk in accordance with present invention.

### DESCRIPTION OF THE PREFERRED EMBODIMENT

FIGS. 1 and 2 show a cartridge having two half shells, a bottom half 11 and top half 12 joined together at 13. An opening 14 in the front of the cartridge provides access for read/write heads. A flexible door 17 covers the opening when the cartridge is removed from the drive. Recording disks 15 and 16 are mounted on a hub 19 (FIG. 2).

As a spindle motor in the drive rotates the disks, the disks 15 and 16 are each engaged by a pair of opposed read/write heads in the drive. Debris must be cleaned from these heads for proper operation of the data storage drive.

The head cleaning disks of the present invention are enclosed in the same type of cartridge as shown in FIGS. 1 and 2. The disks are different and do not have a magnetic coating and undercoating on a substrate as do the recording disks 15 and 16.

FIG. 3 shows the cleaning disks in accordance with the present invention. Two textured substrates 20 are mounted on the hub 19. Substrate 20 is a substrate such as aluminum or glass of the type commonly used in hard disk drives. In accordance with the invention the substrate is textured to provide light abrasion with the disks. Molded plastic or ceramic material can also be used as the cleaning disk. It does not have the magnetic film and NI-P under layer which are commonly provided on such hard disks. This provides a significant cost savings in the cost of the cleaning cartridge. Each cleaning disk of the present invention has a diamond-like coating 21 and 22 directly on the surface of the textured substrate. The cleaning disks have approximately the same thickness as the recording disk 15 and 16. The thickness of the DLC overcoat is greater than would be possible if a DLC coating were applied to a conventional hard disk because of the absence of the magnetic film and the under layer. As a result, the cleaning disk has approximately the same thickness as a normal magnetic disk. This is important to achieve proper head to disk contact. However, the thicker layer of DLC leads to a longer usage life for the cleaning disk.

A layer of lubricant can also be applied over the top of the DLC coating.

A lubricant layer helps to prolong the life of the cleaning disk. Typical lubricants such as those used on disk surfaces are suitable for use. Z-Dol™ is a typical disk surface lubricant

One particular embodiment of the invention has been shown and described. Various modifications may be made. All such modifications within the true spirit and scope of the invention are covered by the appended claims.

1. A cleaning cartridge for a removable cartridge data storage drive having a spindle motor for rotating a data storage medium in a removable cartridge in juxtaposition to read/write heads when said removable cartridge is inserted into said drive, said cleaning cartridge comprising;
a shell;
a hub in said shell rotatable by said spindle motor;
a textured substrate on said hub.

2. The cleaning cartridge recited in claim 1 further comprising:
protective coatings on said textured substrate.

3. The cleaning cartridge recited in claim 2 wherein said protective coatings are diamond-like carbon coatings.

4. The cleaning cartridge recited in claim 2 wherein said protective coatings are lubricants.

5. The cleaning cartridge recited in claim 1 further comprising:
a second textured substrate on said hub; and
coatings on said substrate and on said second substrate for cleaning said heads in said drive when said cleaning cartridge is in said drive and said spindle motor rotates said hub.

6. The cleaning cartridge recited in claim 1 wherein said drive has two opposed read/write heads for reading/writing data on both sides of said data storage medium further comprising:
protective coatings on both sides of said textured substrate.

7. The cleaning cartridge recited in claim 6 wherein said textured substrate and said coatings have a thickness which approximates the thickness of said data storage medium.

8. A cleaning cartridge for a removable cartridge data storage drive having a spindle motor for rotating a data storage medium in a removable cartridge in juxtaposition to a read/write head when said removable cartridge is inserted into said drive, said cleaning cartridge comprising;
a shell;
a hub in said shell rotatable by said spindle motor;
a textured substrate on said hub; and
a diamond-like coating on said substrate for cleaning said head when said cleaning cartridge is in said drive and said spindle motor rotates said hub

9. The cleaning cartridge recited in claim 8 further comprising:
a second textured substrate on said hub; and
diamond-like coatings on said second substrate for cleaning a second set of heads in said drive when said cleaning cartridge is in said drive and said spindle motor rotates said hub.

10. The cleaning cartridge recited in claim 8 wherein said drive has two opposed read/write heads for reading /writing data on both sides of said data storage medium further comprising:
another diamond-like coating on the other side of said textured substrate.

11. The cleaning cartridge recited in claim 10 wherein said textured substrate, said diamond-like coating and said other diamond-like coating have a thickness which approximates the thickness of said data storage medium.
